(19) United States
(12) Patent Application Publication
(10) Pub. No.: US 2025/0076046 A1
(43) Pub. Date: Mar. 6, 2025

(54) SENSOR, SENSOR SYSTEM, AND ELECTRONIC DEVICE

(71) Applicant: KABUSHIKI KAISHA TOSHIBA, Tokyo (JP)

(72) Inventors: Hideaki MURASE, Yokohama Kanagawa (JP); Yasushi TOMIZAWA, Fuchu Tokyo (JP); Daiki ONO, Yokohama Kanagawa (JP); Fumito MIYAZAKI, Yokohama Kanagawa (JP); Kengo UCHIDA, Kawasaki Kanagawa (JP); Kei MASUNISHI, Kawasaki Kanagawa (JP)

(73) Assignee: KABUSHIKI KAISHA TOSHIBA, Tokyo (JP)

(21) Appl. No.: 18/731,806

(22) Filed: Jun. 3, 2024

(30) Foreign Application Priority Data
Aug. 29, 2023 (JP) 2023-139068

(51) Int. Cl. G01C 19/5677

(52) U.S. Cl. CPC G01C 19/5677

(57) ABSTRACT

According to one embodiment, a sensor includes a base including a first face, a fixed portion fixed to the first face, and a movable portion supported by the fixed portion. The movable portion includes a plurality of annular portions, a plurality of connect portions, and a first radial structure. Each of the plurality of annular portions is provided around the fixed portion with the fixed portion as a center in a first plane along the first face. The plurality of connect portion extend along a radial direction. One of the plurality of connect portions connects two of the plurality of annular portions to each other. The plurality of annular portions include a first annular portion and a second annular portion. The first radial structure is connected to the first annular portion. The first radial structure extends toward the second annular portion along a first radial direction.

### CROSS-REFERENCE TO RELATED APPLICATIONS

This application is based upon and claims the benefit of priority from Japanese Patent Application No. 2023-139068, filed on Aug. 29, 2023; the entire contents of which are incorporated herein by reference.

### FIELD

Embodiments described herein relate generally to a sensor, a sensor system, and an electronic device.

### BACKGROUND

For example, there are sensors having a MEMS (Micro Electro Mechanical Systems) structure. In some cases, electronic devices and the like are controlled based on information obtained by sensors. It is desired to improve the characteristics of sensors.

### BRIEF DESCRIPTION OF THE DRAWINGS

FIG. 1 is a schematic plan view illustrating a sensor according to a first embodiment;

FIG. 2 is a schematic cross-sectional view illustrating the sensor according to the first embodiment;

FIG. 3 is a schematic cross-sectional view illustrating the sensor according to the first embodiment;

FIG. 4 is a schematic cross-sectional view illustrating the sensor according to the first embodiment;

FIG. 5 is a schematic cross-sectional view illustrating the sensor according to the first embodiment;

FIG. 6 is a schematic cross-sectional view illustrating the sensor according to the first embodiment;

FIG. 7 is a schematic plan view illustrating a sensor according to the first embodiment;

FIG. 8 is a schematic plan view illustrating a part of the sensor according to the first embodiment;

FIG. 9 is a schematic plan view illustrating a sensor according to the first embodiment;

FIG. 10 is a schematic plan view illustrating a sensor according to the first embodiment;

FIG. 11 is a schematic diagram illustrating an electronic device according to a second embodiment;

FIGS. 12A to 12H are schematic views illustrating applications of the electronic device according to the embodiment; and

FIGS. 13A and 13B are schematic views illustrating applications of the sensor according to the embodiment.

### DETAILED DESCRIPTION

According to one embodiment, a sensor includes a base including a first face, a fixed portion fixed to the first face, and a movable portion supported by the fixed portion. A first gap is provided between the first face and the movable portion. The movable portion includes a plurality of annular portions, a plurality of connect portions, and a first radial structure. Each of the plurality of annular portions is provided around the fixed portion with the fixed portion as a center in a first plane along the first face. The plurality of connect portion extend along a radial direction. The radial direction passes through a first center of the fixed portion in the first plane and is along the first plane. One of the plurality of connect portions connects two of the plurality of annular portions to each other. The plurality of annular portions include a first annular portion and a second annular portion. The second annular portion is next to the first annular portion among the plurality of annular portions. The first radial structure is connected to the first annular portion. The first radial structure extends toward the second annular portion along a first radial direction. The first radial direction passes through the first center and is along the first plane. A first radial gap is provided between the first radial structure and the second annular portion.

Various embodiments are described below with reference to the accompanying drawings.

The drawings are schematic and conceptual; and the relationships between the thickness and width of portions, the proportions of sizes among portions, etc., are not necessarily the same as the actual values. The dimensions and proportions may be illustrated differently among drawings, even for identical portions.

In the specification and drawings, components similar to those described previously or illustrated in an antecedent drawing are marked with like reference numerals, and a detailed description is omitted as appropriate.

### First Embodiment

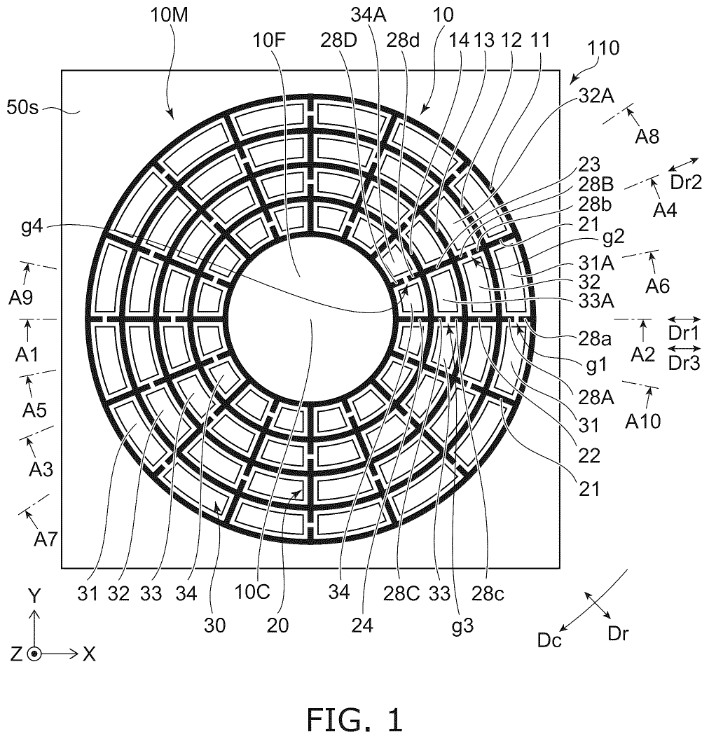

FIG. 1 is a schematic plan view illustrating a sensor according to the first embodiment.

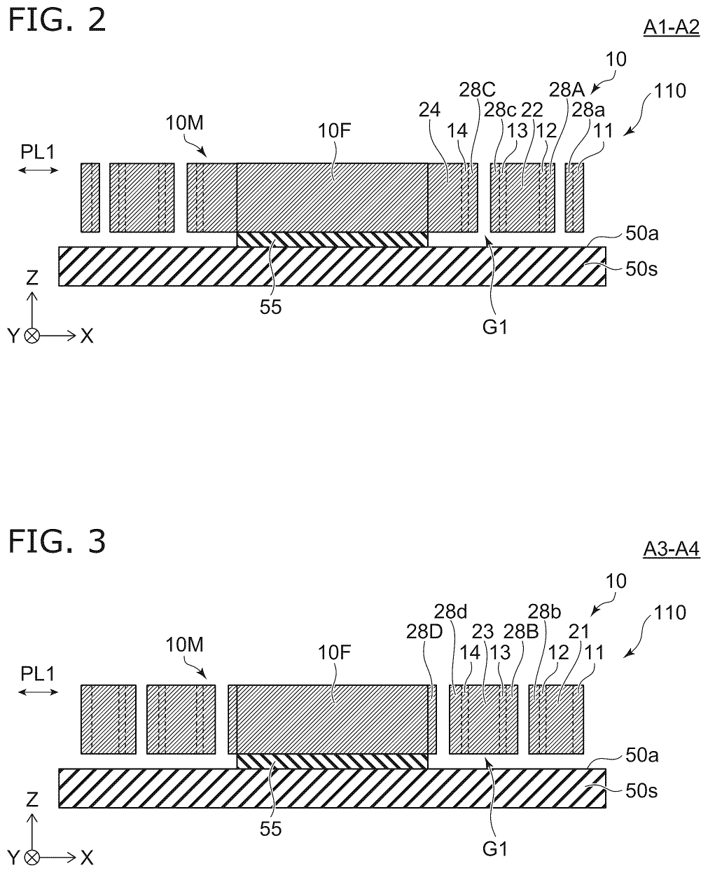

FIGS. 2 to 6 are schematic cross-sectional views illustrating the sensor according to the first embodiment.

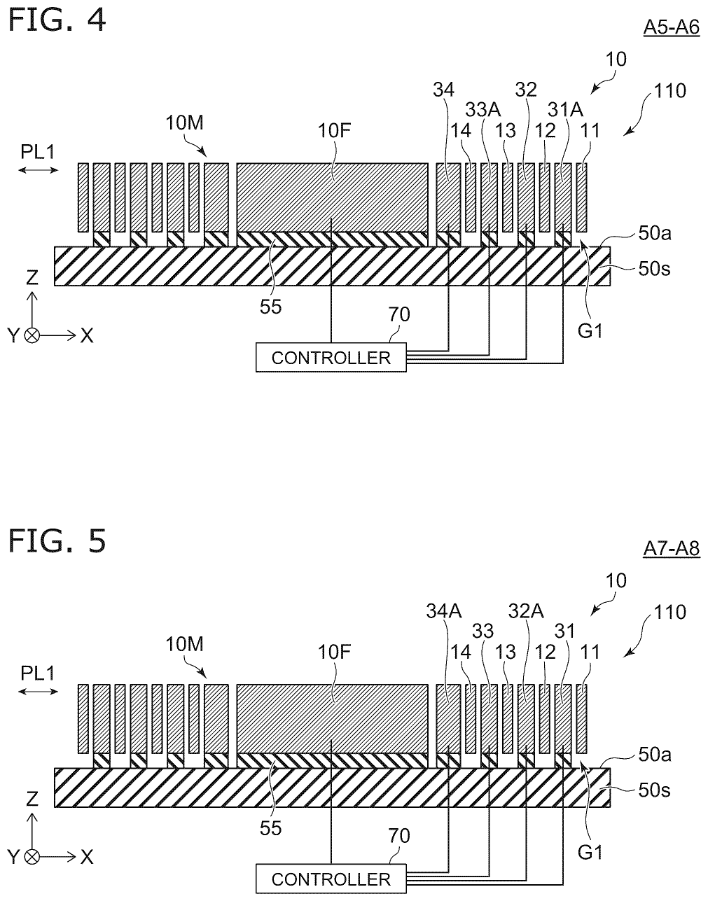

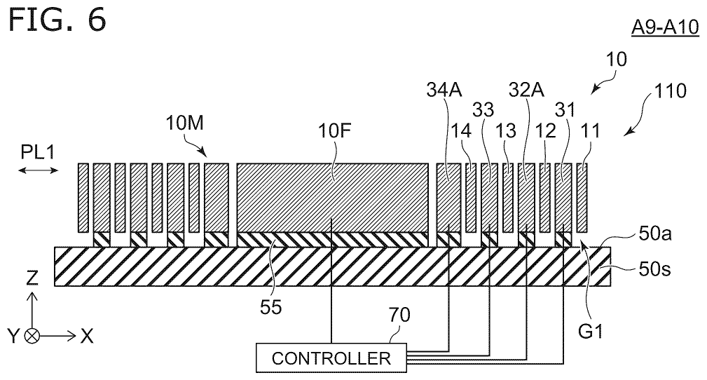

FIG. 2 is a sectional view taken along the line A1-A2 in FIG. 1. FIG. 3 is a sectional view taken along the line A3-A4 in FIG. 1. FIG. 4 is a sectional view taken along the line A5-A6 in FIG. 1. FIG. 5 is a sectional view taken along the line A7-A8 in FIG. 1. FIG. 6 is a sectional view taken along the line A9-A10 in FIG. 1.

As shown in FIGS. 1 to 6, a sensor 110 according to the embodiment includes a base 50s, a fixed portion 10F, and a movable portion 10M.

The base 50s includes a first face 50a. The fixed portion 10F is fixed to the first face 50a. The movable portion 10M is supported by the fixed portion 10F.

As shown in FIGS. 2 to 6, a first gap G1 is provided between the first face 50a and the movable portion 10M. For example, an insulating member 55 is provided on the first face 50a. The fixed portion 10F is provided on the insulating member 55. The insulating member 55 is not provided between the first face 50a and the movable portion 10M.

The movable portion 10M is electrically conductive. The movable portion 10M may include, for example, conductive silicon. The fixed portion 10F is electrically conductive. The fixed portion 10F may include, for example, conductive silicon. The fixed portion 10F is electrically connected to the movable portion 10M. The insulating member 55 may include, for example, silicon oxide.

The movable portion 10M includes a plurality of annular portions 10, a plurality of connect portions 20, and a first radial structure 28a. Each of the plurality of annular portions 10 is provided around the fixed portion 10F with the fixed portion 10F as a center on a first plane PL1 along the first face 50a.

A direction perpendicular to the first plane PL1 is defined as a Z-axis direction. One direction perpendicular to a Z-axis direction is defined as an X-axis direction. A direction perpendicular to the Z-axis direction and the X-axis direction is defined as a Y-axis direction. The first plane PL1 is parallel to the X-Y plane.

For example, each of the plurality of annular portions 10 is concentric with the fixed portion 10F as a center. Each of the plurality of annular portions 10 extends along a circumferential direction Dc.

As shown in FIG. 1, the plurality of connect portions 20 extend along a radial direction Dr. The radial direction Dr passes through the first center 10C of the fixed portion 10F in the first plane PL1 and is along the first plane PL1. One of the plurality of connect portions 20 connects two of the plurality of annular portions 10 to each other.

In this example, the plurality of annular portions 10 include a first annular portion 11, a second annular portion 12, a third annular portion 13, and a fourth annular portion 14. In this example, the first annular portion 11 is the outermost portion. The second annular portion 12 is provided between the fixed portion 10F and the first annular portion 11. The third annular portion 13 is provided between the fixed portion 10F and the second annular portion 12. The fourth annular portion 14 is provided between the fixed portion 10F and the third annular portion 13. In the embodiment, the first annular portion 11 may not be the outermost portion, as will be described later. In the embodiment, the number of the plurality of annular portions 10 is arbitrary.

In this example, the plurality of connect portions 20 include a first connect portion 21, a second connect portion 22, a third connect portion 23, and a fourth connect portion 24. The first connect portion 21 is provided between the second annular portion 12 and the first annular portion 11. The first connect portion 21 connects the second annular portion 12 to the first annular portion 11. The second connect portion 22 is provided between the third annular portion 13 and the second annular portion 12. The second connect portion 22 connects the third annular portion 13 to the second annular portion 12. The third connect portion 23 is provided between the fourth annular portion 14 and the third annular portion 13. The third connect portion 23 connects the fourth annular portion 14 to the third annular portion 13. The fourth connect portion 24 is provided between the fixed portion 10F and the fourth annular portion 14. The fourth connect portion 24 connects the fourth annular portion 14 to the fixed portion 10F.

The second annular portion 12 is next to the first annular portion 11 among the plurality of annular portions 10. The second annular portion 12 is closest to the first annular portion 11 among the plurality of annular portions 10. The second annular portion 12 may be provided inside the first annular portion 11. Alternatively, the first annular portion 11 may be provided inside the second annular portion 12.

The first radial structure 28a is connected to the first annular portion 11. The first radial structure 28a extends toward the second annular portion 12 along a first radial direction Dr1. The first radial direction passes through the first center 10C and is along the first plane PL1. A first radial gap g1 is provided between the first radial structure 28a and the second annular portion 12. The first radial structure 28a is separated from the second annular portion 12.

As shown in FIG. 1, in the sensor 110, a plurality of fixed electrodes 30 are provided. For example, the plurality of fixed electrodes 30 are fixed to the first face 50a. For example, a signal including an alternating component is applied between a part of the plurality of fixed electrodes 30 and the movable portion 10M. Thereby, the movable portion 10M vibrates. The signal may include an X-axis component and a Y-axis component. When an external force is applied to the movable portion 10M vibrating, the vibration state changes. By detecting a change in the vibration state, the applied external force can be detected. The change in the vibration state is detected as a change in capacitance, for example. The changes in the vibration state due to external forces are caused by, for example, Coriolis force. The change in the vibration state can be detected, for example, by another part of the plurality of fixed electrodes 30. The signal may be supplied by a controller 70, for example. For example, the controller 70 may detect the change in the vibration state.

In the embodiment, for example, the plurality of fixed electrodes 30 include a first fixed electrode 31. The first fixed electrode 31 is provided between the second annular portion 12 and the first annular portion 11 in the radial direction Dr. The first fixed electrode 31 is provided between the first connect portion 21 and the first radial structure 28a in a circumferential direction Dc. In the circumferential direction Dc, one end of the first fixed electrode 31 faces the first radial gap g1. In the circumferential direction Dc, one end of the first fixed electrode 31 is open. With such a configuration, the movable portion 10M has appropriate flexibility. The movable portion 10M can vibrate with an appropriate degree of freedom. The movable portion 10M can vibrate in a stable state around the first fixed electrode 31.

For example, in a first reference example, the first connect portion 21 is also provided at a location where the first radial structure 28a is provided. In the first reference example, the first fixed electrode 31 is surrounded by the second annular portion 12, the first annular portion 11, and the two of the first connect portion 21 in the radial direction Dr and the circumferential direction Dc. In the first reference example, the first radial gap g1 is not provided. In such a first reference example, the movable portion 10M is mechanically strong, and it is difficult to obtain the desired vibration.

In contrast, in the embodiment, one end of the first fixed electrode 31 faces the first radial gap g1 in the circumferential direction Dc. The movable portion 10M can vibrate with appropriate degree of freedom. Vibration with stable state is obtained. High signal strength based on the vibration is obtained. Highly sensitive detection becomes possible. According to the embodiment, it is possible to provide a sensor whose characteristics can be improved.

As shown in FIG. 1, the plurality of first fixed electrodes 31 are provided along the circumferential direction Dc. The number of the plurality of first fixed electrodes 31 may be 16 or more. Thereby, for example, a vibration state in any direction can be detected while compensating the anisotropy of the resonance frequency.

In such a configuration, a second reference example can be considered in which the first connect portion 21 is not provided between two of the first fixed electrodes 31. In the second reference example, the first radial structure 28a is not provided. In the second reference example, a gap with a large area exists between the two of the first fixed electrodes 31. The movable portion 10M is formed by removing a part of the movable member served as the movable portion 10M. In this processing, the etching rate is locally increased around a gap of a large area. Thereby, parts of the first annular portion 11 and the second annular portion 12 corresponding to the gap are excessively etched. Thereby, in the second reference example, it is difficult to obtain the plurality of annular portions 10 having a uniform width. In the second reference example, it is difficult to detect with high accuracy.

In contrast, in the embodiment, the first radial structure 28a is provided between the two of the first fixed electrodes 31. Thereby, the area of the gap between the two of the first fixed electrodes 31 can be made smaller compared to the second reference example. Excessive etching is suppressed in the region corresponding between the two of the first fixed electrodes 31. The plurality of annular portions 10 having a uniform width can be obtained. According to the embodiment, a plurality of annular portions 10 having a desired shape can be obtained with high accuracy. By the plurality of annular portions 10 being highly accurate, highly accurate detection can be possible. According to the embodiment, it is possible to provide a sensor whose characteristics can be improved.

For example, by providing the first radial structure 28a, local etching of the first annular portion 11 is suppressed.

As shown in FIG. 1, in the sensor 110, the movable portion 10M may further include a first opposing radial structure 28A. The first opposing radial structure 28A is connected to the second annular portion 12. The first opposing radial structure 28A extends toward the first radial structure 28a along the first radial direction Dr1. The first radial gap g1 is provided between the first radial structure 28a and the first opposing radial structure 28A.

By providing the first opposing radial structure 28A, local etching of the second annular portion 12 is suppressed.

As shown in FIG. 1, the sensor 110 may include the first fixed electrode 31 and a first other fixed electrode 31A. The first fixed electrode 31 and the first other fixed electrode 31A are fixed to the first face 50a (see FIGS. 4 to 6). As shown in FIG. 1, the first fixed electrode 31 and the first other fixed electrode 31A are provided between the second annular portion 12 and the first annular portion 11. At least a part of the first radial structure 28a is provided between the first fixed electrode 31 and the first other fixed electrode 31A in the circumferential direction Dc centered on the fixed portion 10F along the first plane PL1. For example, in the circumferential direction Dc, at least a part of the first opposing radial structure 28A is provided between the first fixed electrode 31 and the first other fixed electrode 31A.

As shown in FIG. 1, the first fixed electrode 31 is provided between the first radial structure 28a and the first connect portion 21 in the circumferential direction Dc. In the circumferential direction Dc, the first fixed electrode 31 is provided between the first opposing radial structure 28A and the first connect portion 21.

As shown in FIG. 1, the movable portion 10M may further include a second radial structure 28b. In this example, the second annular portion 12 is provided between the fixed portion 10F and the first annular portion 11. The third annular portion 13 is provided between the fixed portion 10F and the second annular portion 12. The third annular portion 13 is next to the second annular portion 12 among the plurality of annular portions 10. The second radial structure 28b is connected to the second annular portion 12. The second radial structure 28b extends toward the third annular portion 13 along a second radial direction Dr2. The second radial direction Dr2 passes through the first center 10C and is along the first plane PL1. A second radial gap g2 is provided between the second radial structure 28b and the third annular portion 13.

By providing such a second radial structure 28b, it is easy to obtain the desired vibration in the movable portion 10M. Highly accurate detection is possible. For example, excessive local etching of the second annular portion 12 can be suppressed.

In this example, the second radial direction Dr2 crosses the first radial direction Dr1. In the embodiment, the second radial direction Dr2 may be along the first radial direction Dr1.

As shown in FIG. 1, the movable portion 10M may further include a second opposing radial structure 28B. The second opposing radial structure 28B is connected to the third annular portion 13. The second opposing radial structure 28B extends toward the second radial structure 28b along a second radial direction Dr2. The second radial gap g2 is provided between the second radial structure 28b and the second opposing radial structure 28B.

By providing such a second opposing radial structure 28B, it is easy to obtain the desired vibration in the movable portion 10M. Highly accurate detection is possible. For example, excessive local etching of the third annular portion 13 can be suppressed.

As shown in FIG. 1, the sensor 110 may further include a second fixed electrode 32 and a second other fixed electrode 32A. The second fixed electrode 32 and the second other fixed electrode 32A are fixed to the first face 50a. The second fixed electrode 32 and the second other fixed electrode 32A are provided between the third annular portion 13 and the second annular portion 12. At least a part of the second radial structure 28b is provided between the second fixed electrode 32 and the second other fixed electrode 32A in the circumferential direction Dc centered on the fixed portion 10F along the first plane PL1.

For example, the second fixed electrode 32 is provided between the second connect portion 22 and the second radial structure 28b in the circumferential direction Dc.

As shown in FIG. 1, the movable portion 10M may further include a third radial structure 28c. The plurality of annular portions 10 may further include the third annular portion 13 and the fourth annular portion 14. The fourth annular portion 14 is next to the third annular portion 13 among the plurality of annular portions 10. The third radial structure 28c is connected to the third annular portion 13. The third radial structure 28c extends toward the fourth annular portion 14 along a third radial direction Dr3. The third radial direction Dr3 passes through the first center 10C and is along the first plane PL1. A third radial gap g3 is provided between the third radial structure 28c and the fourth annular portion 14.

For example, the third radial direction Dr3 is along the first radial direction Dr1. In the embodiment, the third radial direction Dr3 may cross the first radial direction Dr1.

The movable portion 10M may further include a third opposing radial structure 28C. The third opposing radial structure 28C is connected to the fourth annular portion 14. The third opposing radial structure 28C extends toward the third radial structure 28c along the third radial direction Dr3. The third radial gap g3 may be provided between the third radial structure 28c and the third opposing radial structure 28C.

The sensor 110 may further include a third fixed electrode 33 and a third other fixed electrode 33A. The third fixed electrode 33 and the third other fixed electrode 33A are fixed to the first face 50a. The third fixed electrode 33 and the third other fixed electrode 33A are provided between the fourth annular portion 14 and the third annular portion 13. In the circumferential direction Dc centered on the fixed portion 10F along the first plane PL1, at least a part of the third radial structure 28c is provided between the third fixed electrode 33 and the third other fixed electrode 33A.

For example, the third fixed electrode 33 is provided between the third connect portion 23 and the third radial structure 28c in the circumferential direction Dc.

As shown in FIG. 1, the movable portion 10M may further include a fourth radial structure 28d. The plurality of annular portions 10 further include the fourth annular portion 14. The fourth annular portion 14 is provided between the fixed portion 10F and the third annular portion 13. The fourth radial structure 28d is connected to the fourth annular portion 14. In this example, the fourth radial structure 28d extends toward the fixed portion 10F along the second radial direction Dr2. A fourth radial gap g4 is provided between the fourth radial structure 28d and the fixed portion 10F.

As shown in FIG. 1, the movable portion 10M may further include a fourth opposing radial structure 28D. The fourth opposing radial structure 28D is connected to the fixed portion 10F. The fourth opposing radial structure 28D extends toward the fourth radial structure 28d along the second radial direction Dr2. The fourth radial gap g4 is provided between the fourth radial structure 28d and the fourth opposing radial structure 28D.

The sensor 110 may further include a fourth fixed electrode 34 and a fourth other fixed electrode 34A. The fourth fixed electrode 34 and the fourth other fixed electrode 34A are fixed to the first face 50a. The fourth fixed electrode 34 and the fourth other fixed electrode 34A are provided between the fixed portion 10F and the fourth annular portion 14. At least a part of the fourth radial structure 28d is provided between the fourth fixed electrode 34 and the fourth other fixed electrode 34A in the circumferential direction Dc centered on the fixed portion 10F along the first plane PL1.

For example, the fourth fixed electrode 34 is provided between the fourth connect portion 24 and the fourth radial structure 28d in the circumferential direction Dc.

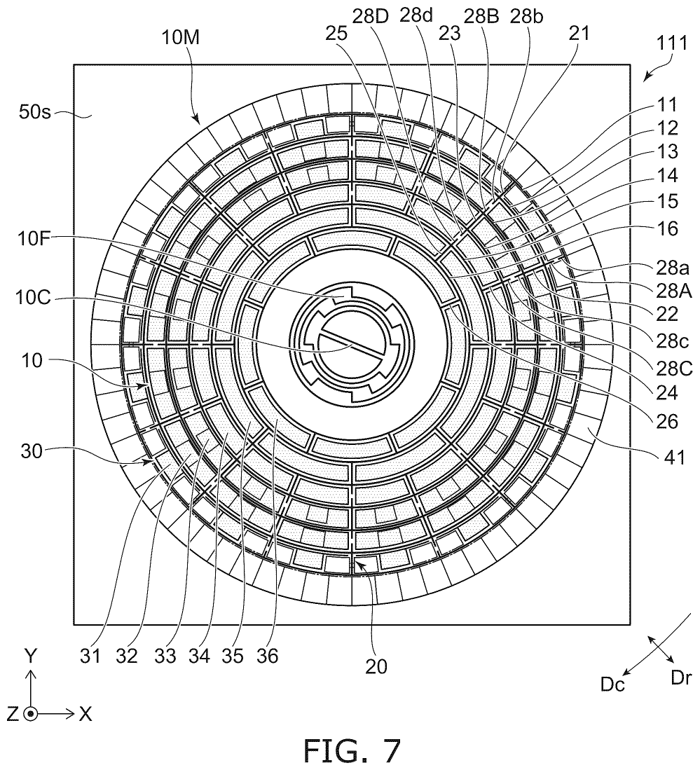

FIG. 7 is a schematic plan view illustrating a sensor according to the first embodiment.

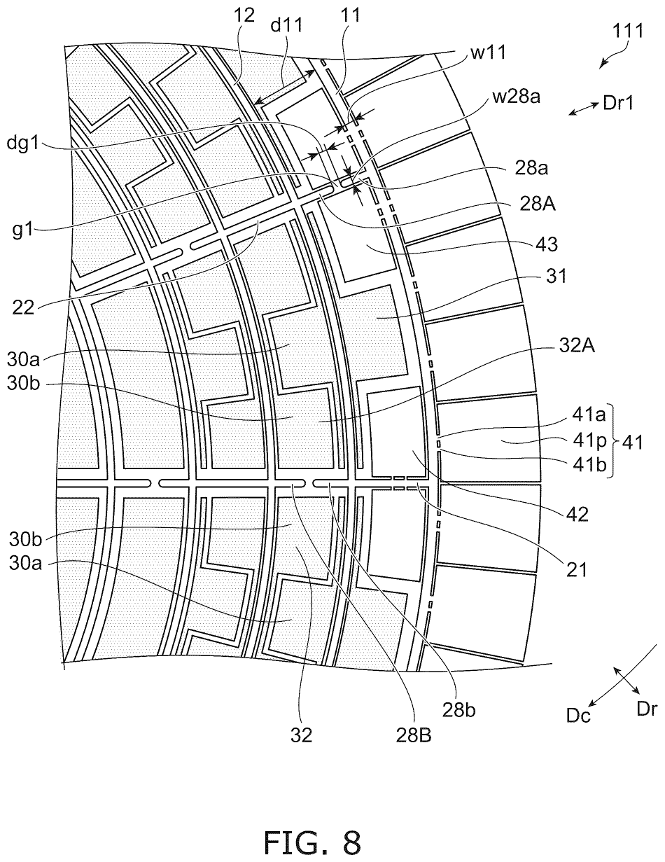

FIG. 8 is a schematic plan view illustrating a part of the sensor according to the first embodiment.

As shown in FIG. 7, in a sensor 111 according to the embodiment, the movable portion 10M includes a first structure 41. The configuration of the sensor 111 except for this may be the same as the configuration of the sensor 110.

FIG. 8 shows a portion including the first structure 41 in an enlarged manner. In this example, the first structure 41 is connected to the first annular portion 11. In this example, the first annular portion 11 is the outermost portion. The first structure 41 functions as a mass member, for example. BY providing the first structure 41, the vibration of the movable portion 10M is stabilized. Noise can be suppressed in signals associated with the vibration. Detection with higher accuracy is possible.

For example, a length of the first structure 41 in the radial direction Dr is longer than a length of the first annular portion 11 in the radial direction Dr. For example, the length of the first structure 41 in the radial direction Dr is longer than a distance between the second annular portion 12 and the first annular portion 11 in the radial direction Dr.

A plurality of first structures 41 may be provided. The plurality of first structures 41 are arranged along the circumferential direction Dc. The plurality of first structures 41 and the first annular portion 11 may satisfy at least one of a first condition, a second condition, or a third condition. In the first condition, a sum (first sum) of the areas in the first plane PL1 of each of the plurality of first structures 41 is larger than an area (first annular portion area) in the first plane PL1 of the first annular portion 11. In the second condition, a sum (second sum) of the volumes of each of the plurality of first structures 41 is larger than a volume (first annular portion volume) of the first annular portion 11. In the third condition, a sum (third sum) of the masses of each of the plurality of first structures 41 is larger than a mass (first annular portion mass) of the first annular portion 11.

As shown in FIG. 8, the first structure 41 may include a first structure component 41p and a first structure connect portion 41a. The first structure connect portion 41a is provided between the first annular portion 11 and the first structure component 41p. The first structure connect portion 41a connects the first structure component 41p to the first annular portion 11. A length of the first structure connect portion 41a in the circumferential direction Dc centered on the fixed portion 10F along the first face 50a is shorter than a length of the first structure component 41p in the circumferential direction Dc.

The first structure 41 may further include a second structure connect portion 41b. The second structure connect portion 41b is provided between the first annular portion 11 and the first structure component 41p, and connects the first structure component 41p to the first annular portion 11. A direction from the first structure connect portion 41a to the second structure connect portion 41b is along the circumferential direction Dc.

At least one of the plurality of fixed electrodes 30 (in this example, the second fixed electrode 32 or the second other fixed electrode 32A) includes a plurality of partial electrodes. The plurality of partial electrodes include a first partial electrode 30a and a second partial electrode 30b. The first partial electrode 30a and the second partial electrode 30b are arranged in the circumferential direction Dc.

As shown in FIG. 8, a length of the first radial gap g1 in the first radial direction Dr1 is defined as a length dg1. A distance in the first radial direction Dr1 between the second annular portion 12 and the first annular portion 11 is defined as distance d11. The length dg1 is preferably, for example, not less than 0.1 times and not more than 0.9 times of the distance d11. When the length dg1 is excessively long, for example, excessive etching of the annular portion 10 is likely to occur. When the length dg1 is excessively short, for example, the mechanical strength of the first radial structure 28a is likely to decrease.

As shown in FIG. 8, an end of the first radial structure 28a may have a curved shape. An end of the first opposing radial structure 28A may have a curved shape.

As shown in FIG. 8, a length of the first radial structure 28a in the circumferential direction Dc is defined as a first radial structure length w28a. A length of the first annular portion 11 in the radial direction Dr is defined as a first annular portion width w11. For example, the first radial structure length w28a may be not less than 0.2 times and not more than 2 times the first annular portion width w11.

As shown in FIG. 7, in this example, the plurality of annular portions 10 include a fifth annular portion 15 and a sixth annular portion 16. The fifth annular portion 15 is provided between the fixed portion 10F and the fourth annular portion 14. The sixth annular portion 16 is provided between the fixed portion 10F and the fifth annular portion 15.

As shown in FIG. 7, in this example, the plurality of connect portions 20 include a fifth connect portion 25 and a sixth connect portion 26. The fifth connect portion 25 connects the sixth annular portion 16 to the fifth annular portion 15. The sixth connect portion 26 connects the sixth annular portion 16 to the fixed portion 10F.

As shown in FIG. 7, in this example, the plurality of fixed electrodes 30 include a fifth fixed electrode 35 and a sixth fixed electrode 36. The fifth fixed electrode 35 is provided between the sixth annular portion 16 and the fifth annular portion 15. The sixth fixed electrode 36 is provided between the fixed portion 10F and the sixth annular portion 16.

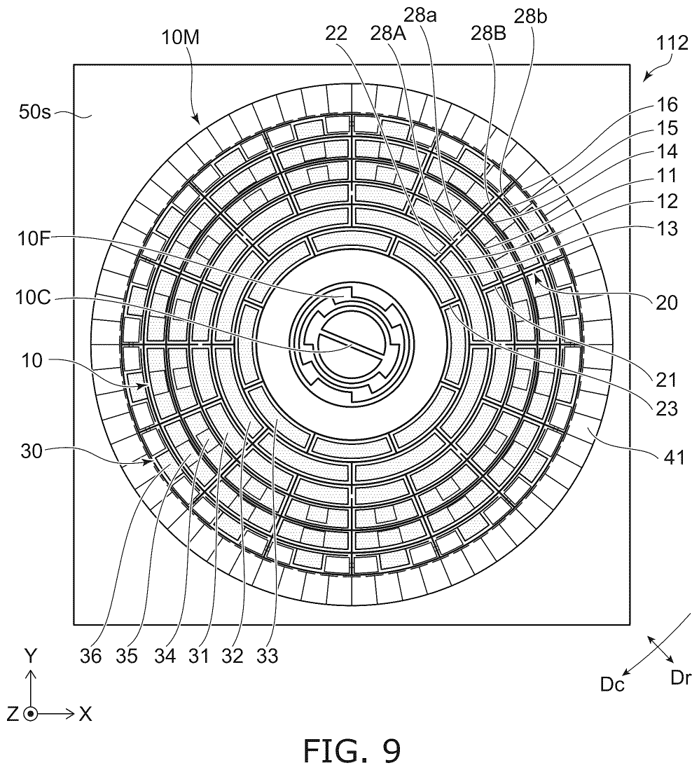

FIG. 9 is a schematic plan view illustrating a sensor according to the first embodiment.

As shown in FIG. 9, in a sensor 112 according to the embodiment, the first annular portion 11 is not the outermost portion. In the radial direction Dr, the first annular portion 11 is provided between the plurality of annular portions 10. The configuration of the sensor 112 except for this may be the same as the configuration of the sensor 110 or the sensor 111.

In the sensor 112, the first radial structure 28a is connected to the first annular portion 11. The first opposing radial structure 28A is connected to the second annular portion 12. In the sensor 112, highly accurate detection can be obtained as well.

FIG. 10 is a schematic plan view illustrating a sensor according to the first embodiment.

FIG. 10 illustrates the fixed portion 10F and the movable portion 10M. In a sensor 120 according to the embodiment, at least one of the plurality of fixed electrodes 30 includes a plurality of partial electrodes. The configuration of the sensor 120 except for this may be the same as the configuration of the sensor 110 and the like.

In this example, at least one of the plurality of fixed electrodes 30 is the second fixed electrode 32. The second fixed electrode 32 includes a plurality of partial electrodes. The plurality of partial electrodes include a first partial electrode 30a and a second partial electrode 30b. The first partial electrode 30a and the second partial electrode 30b are arranged in the circumferential direction Dc. In this example, two of the second partial electrode 30b are provided. The first partial electrode 30a is provided between the two of the partial electrodes in the circumferential direction Dc. Different signals may be supplied to the plurality of partial electrodes. Signals resulting from multiple partial electrodes may be processed to perform detection.

As shown in FIG. 10, in this example, a direction in which the second connect portion 22 extends is along a direction in which the third connect portion 23 extends. For example, it becomes easier to obtain a detection signal with high intensity.

As shown in FIG. 10, the sensor 120 may include a connect member 48. The connect member 48 is fixed to the first face 50a. The fixed portion 10F is provided around the connect member 48. Electrical connections may be made via the connect member 48. In this example, the connect member 48 includes a first connect member 48a and a second connect member 48b. The connect member 48 (for example, the first connect member 48a and the second connect member 48b) may be electrically insulated from the fixed portion 10F and the movable portion 10M. At least a part of the connect member 48 (for example, the first connect member 48a and the second connect member 48b, etc.) may be electrically connected to the fixed portion 10F or the movable portion 10M by wiring for electrical connection.

### Second Embodiment

A second embodiment relates to an electronic device.

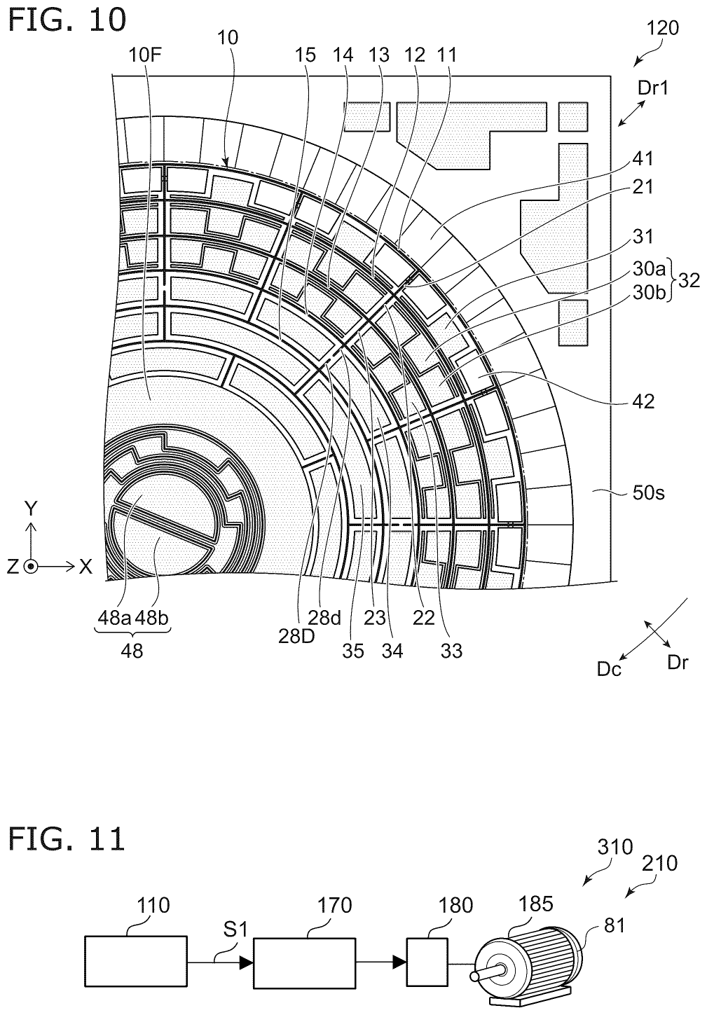

FIG. 11 is a schematic diagram illustrating an electronic device according to a second embodiment.

As shown in FIG. 11, an electronic device 310 according to the embodiment includes the sensors according to the first to third embodiments and the circuit processor 170. In the example of FIG. 11, the sensor 110 is drawn as the sensor. The circuit processor 170 is configured to control a circuit 180 based on the signal S1 obtained from the sensor. The circuit 180 is, for example, a control circuit for a drive device 185. According to the embodiment, for example, the circuit 180 for controlling the drive device 185 can be controlled with high accuracy.

As shown in FIG. 11, the sensor system 210 according to the embodiment includes the sensor (for example, the sensor 110) according to the first embodiment and a detection target member 81. The sensor 110 is fixed to the detection target member 81. The sensor 110 can detect a signal from the detection target member 81.

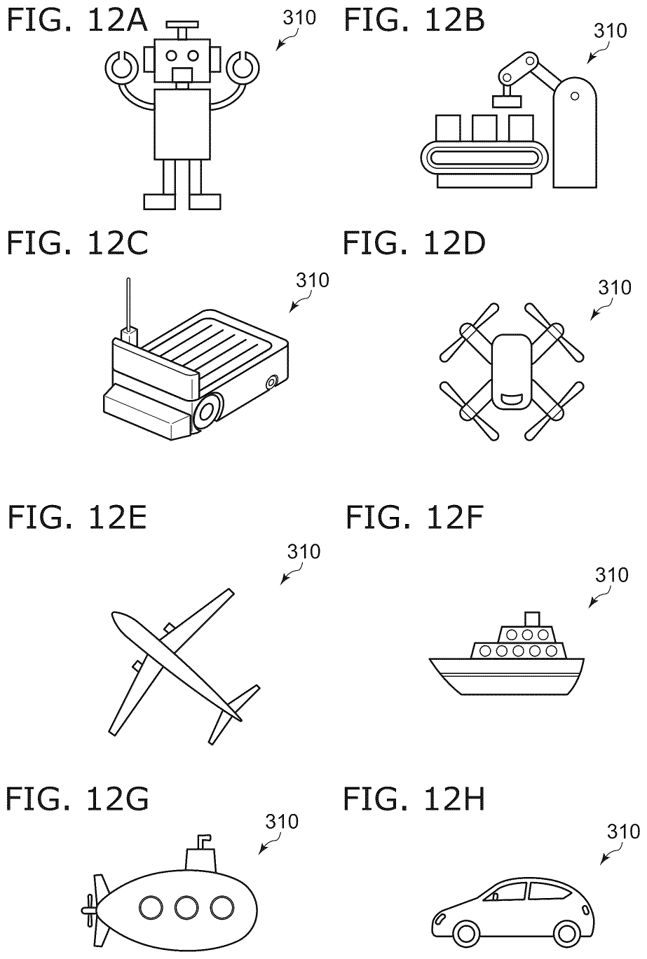

FIGS. 12A to 12H are schematic views illustrating applications of the electronic device according to the embodiment.

As shown in FIG. 12A, the electronic device 310 may be at least a portion of a robot. As shown in FIG. 12B, the electronic device 310 may be at least a portion of a machining robot provided in a manufacturing plant, etc. As shown in FIG. 12C, the electronic device 310 may be at least a portion of an automatic guided vehicle inside a plant, etc. As shown in FIG. 12D, the electronic device 310 may be at least a portion of a drone (an unmanned aircraft). As shown in FIG. 12E, the electronic device 310 may be at least a portion of an airplane. As shown in FIG. 12F, the electronic device 310 may be at least a portion of a ship. As shown in FIG. 12G, the electronic device 310 may be at least a portion of a submarine. As shown in FIG. 12H, the electronic device 310 may be at least a portion of an automobile. The electronic device 310 may include, for example, at least one of a robot or a moving body.

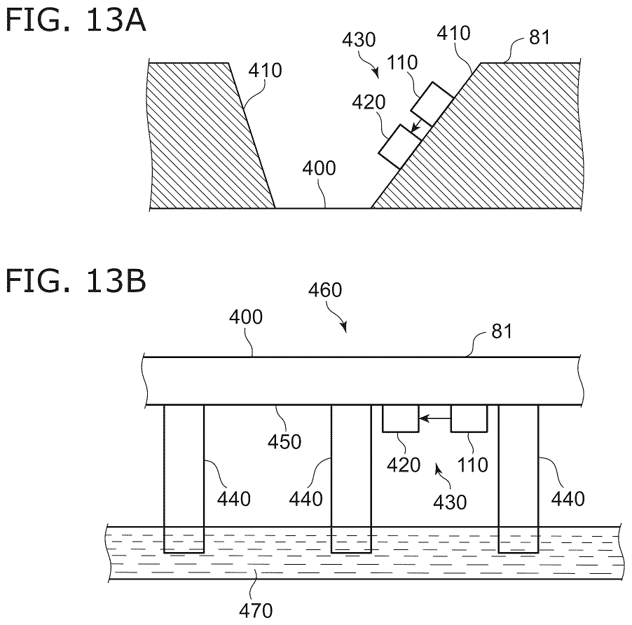

FIGS. 13A and 13B are schematic views illustrating applications of the sensor according to the embodiment.

As shown in FIG. 13A, a sensor 430 according to the fifth embodiment includes the sensor according to one of the first to third embodiments, and a transmission/reception part 420. In the example of FIG. 13A, the sensor 110 is illustrated as the sensor. The transmission/reception part 420 is configured to transmit the signal obtained from the sensor 110 by, for example, at least one of wireless and wired methods. The sensor 430 is provided on, for example, a slope surface 410 such as a road 400. The sensor 430 can monitor the state of, for example, a facility (e.g., infrastructure). The sensor 430 may be, for example, a state monitoring device.

For example, the sensor 430 detects a change in the state of a slope surface 410 of a road 400 with high accuracy. The change in the state of the slope surface 410 includes, for example, at least one of a change in the inclination angle and a change in the vibration state. The signal (inspection result) obtained from the sensor 110 is transmitted by the transmission/reception part 420. The status of a facility (e.g., infrastructure) can be monitored, for example, continuously.

As shown in FIG. 13B, the sensor 430 is provided, for example, in a portion of a bridge 460. The bridge 460 is provided above the river 470. For example, the bridge 460 includes at least one of a main girder 450 and a pier 440. The sensor 430 is provided on at least one of the main girder 450 and the pier 440. For example, at least one of the angles of the main girder 450 and the pier 440 may change due to deterioration or the like. For example, the vibration state may change in at least one of the main girder 450 and the pier 440. The sensor 430 detects these changes with high accuracy. The detection result can be transmitted to an arbitrary place by the transmission/reception part 420. Abnormalities can be detected effectively.

The embodiments may include the following Technical proposals:

### Technical Proposal 1

A sensor, comprising:
a base including a first face;
a fixed portion fixed to the first face; and
a movable portion supported by the fixed portion,
a first gap being provided between the first face and the movable portion,
the movable portion including a plurality of annular portions, a plurality of connect portions, and a first radial structure,
each of the plurality of annular portions being provided around the fixed portion with the fixed portion as a center in a first plane along the first face,
the plurality of connect portion extending along a radial direction,
the radial direction passing through a first center of the fixed portion in the first plane and being along the first plane,
one of the plurality of connect portions connecting two of the plurality of annular portions to each other,
the plurality of annular portions including a first annular portion and a second annular portion,
the second annular portion being next to the first annular portion among the plurality of annular portions,
the first radial structure being connected to the first annular portion,
the first radial structure extending toward the second annular portion along a first radial direction,
the first radial direction passing through the first center and being along the first plane, and
a first radial gap being provided between the first radial structure and the second annular portion.

### Technical Proposal 2

The sensor according to Technical proposal 1, wherein
the second annular portion is provided between the fixed portion and the first annular portion.

### Technical Proposal 3

The sensor according to Technical proposal 1 or 2, wherein
the movable portion further includes a first opposing radial structure,
the first opposing radial structure is connected to the second annular portion,
the first opposing radial structure extends toward the first radial structure along the first radial direction, and
the first radial gap is provided between the first radial structure and the first opposing radial structure.

### Technical Proposal 4

The sensor according to any one of Technical proposals 1-3, further comprising:
a first fixed electrode fixed to the first face; and
a first other fixed electrode fixed to the first face,
the first fixed electrode and the first other fixed electrode being provided between the second annular portion and the first annular portion, and
at least a part of the first radial structure being provided between the first fixed electrode and the first other fixed electrode in a circumferential direction centered on the fixed portion along the first plane.

### Technical Proposal 5

The sensor according to any one of Technical proposals 1-3, further comprising:
a first fixed electrode fixed to the first face,
the first fixed electrode being provided between the second annular portion and the first annular portion,
the plurality of connect portions including a first connect portion,
the first connect portion being provided between the second annular portion and the first annular portion,
the first connect portion connecting the second annular portion to the first annular portion, and
the first fixed electrode being provided between the first radial structure and the first connect portion in a circumferential direction centered on the fixed portion along the first plane.

### Technical Proposal 6

The sensor according to Technical proposal 1, wherein
the movable portion further includes a second radial structure,
the plurality of annular portions further include a third annular portion,
the second annular portion is provided between the fixed portion and the first annular portion,
the third annular portion is provided between the fixed portion and the second annular portion,
the third annular portion is next to the second annular portion among the plurality of annular portions,
the second radial structure is connected to the second annular portion,
the second radial structure extends toward the third annular portion along a second radial direction,
the second radial direction passes through the first center and is along the first plane, and
a second radial gap is provided between the second radial structure and the third annular portion.

### Technical Proposal 7

The sensor according to Technical proposal 6, wherein
the second radial direction is along the first radial direction.

### Technical Proposal 8

The sensor according to Technical proposal 6 or 7, wherein
the movable portion further includes a second opposing radial structure,
the second opposing radial structure is connected to the third annular portion,
the second opposing radial structure extends toward the second radial structure along the second radial direction, and
the second radial gap is provided between the second radial structure and the second opposing radial structure.

### Technical Proposal 9

The sensor according to any one of Technical proposals 6-8, further comprising:
a second fixed electrode fixed to the first face, and a second other fixed electrode fixed to the first face,
the second fixed electrode and the second other fixed electrode being provided between the third annular portion and the second annular portion, and
at least a part of the second radial structure being provided between the second fixed electrode and the second other fixed electrode in a circumferential direction centered on the fixed portion along the first plane.

### Technical Proposal 10

The sensor according to Technical proposal 1, wherein
the movable portion further includes a third radial structure,
the plurality of annular portions further include a third annular portion and a fourth annular portion,
the fourth annular portion is next to the third annular portion among the plurality of annular portions,
the third radial structure is connected to the third annular portion,
the third radial structure extends toward the fourth annular portion along a third radial direction,
the third radial direction passes through the first center and is along the first plane, and
a third radial gap is provided between the third radial structure and the fourth annular portion.

### Technical Proposal 11

The sensor according to Technical proposal 10, wherein
the third radial direction crosses the first radial direction.

### Technical Proposal 12

The sensor according to Technical proposal 10 or 11, wherein
the second annular portion is provided between the fixed portion and the first annular portion,
the third annular portion is provided between the fixed portion and the second annular portion, and
the fourth annular portion is provided between the fixed portion and the third annular portion.

### Technical Proposal 13

The sensor according to any one of Technical proposals 10-12, wherein
the movable portion further includes a third opposing radial structure,
the third opposing radial structure is connected to the fourth annular portion,
the third opposing radial structure extends toward the third radial structure along the third radial direction, and
the third radial gap is provided between the third radial structure and the third opposing radial structure,

### Technical Proposal 14

The sensor according to any one of Technical proposals 10-13, further comprising:
a third fixed electrode fixed to the first surface, and a third other fixed electrode fixed to the first surface,
the third fixed electrode and the third other fixed electrode being provided between the fourth annular portion and the third annular portion, and
at least a part of the third radial structure being provided between the third fixed electrode and the third other fixed electrode in a circumferential direction centered on the fixed portion along the first plane.

### Technical Proposal 15

The sensor according to any one of Technical proposals 6-8, wherein
the movable portion further includes a fourth radial structure,
the plurality of annular portions further include a fourth annular portion,
the fourth annular portion is provided between the fixed portion and the third annular portion,
the fourth radial structure is connected to the fourth annular portion,
the fourth radial structure extends toward the fixed portion along the second radial direction, and
a fourth radiation gap is provided between the fourth radial structure and the fixed portion.

### Technical Proposal 16

The sensor according to Technical proposal 15, wherein
the movable portion further includes a fourth opposing radial structure,
the fourth opposing radial structure is connected to the fixed portion,
the fourth opposing radial structure extends toward the fourth radial structure along the second radial direction, and
the fourth radial gap is provided between the fourth radial structure and the fourth opposing radial structure.

### Technical Proposal 17

The sensor according to Technical proposal 15 or 16, further comprising:
a fourth fixed electrode fixed to the first face, and a fourth other fixed electrode fixed to the first face,
the fourth fixed electrode and the fourth other fixed electrode being provided between the fixed portion and the fourth annular portion, and
at least a part of the fourth radial structure being provided between the fourth fixed electrode and the fourth other fixed electrode in a circumferential direction centered on the fixed portion along the first plane.

### Technical Proposal 18

The sensor according to any one of Technical proposals 1-17, wherein
a length of the first radial gap in the first radial direction is not less than 0.1 times and not more than 0.9 times a distance between the second annular portion and the first annular portion along the first radial direction.

### Technical Proposal 19

A sensor system, comprising:
the sensor according to any one of Technical proposals 1-18; and
a detection target member, the sensor being fixed to the detection target member.

### Technical Proposal 20

An electronic device, comprising:
the sensor according to any one of Technical proposals 1-18; and
a circuit controller configured to control a circuit based on a signal obtained from the sensor.

According to the embodiment, a sensor, a sensor system, and an electronic device whose characteristics can be improved can be provided.

In the specification of the application, “perpendicular” and “parallel” refer to not only strictly perpendicular and strictly parallel but also include, for example, the fluctuation due to manufacturing processes, etc. It is sufficient to be substantially perpendicular and substantially parallel.

Hereinabove, exemplary embodiments of the invention are described with reference to specific examples. However, the embodiments of the invention are not limited to these specific examples. For example, one skilled in the art may similarly practice the invention by appropriately selecting specific configurations of components included in the sensor such as substrates, sensor sections, housings, sensor elements, bases, fixed portions, movable portions, controllers, etc., from known art. Such practice is included in the scope of the invention to the extent that similar effects thereto are obtained.

Further, any two or more components of the specific examples may be combined within the extent of technical feasibility and are included in the scope of the invention to the extent that the purport of the invention is included.

Moreover, all sensors, all sensor systems, and all electronic devices practicable by an appropriate design modification by one skilled in the art based on the sensors, the sensor systems, and the electronic devices described above as embodiments of the invention also are within the scope of the invention to the extent that the purport of the invention is included.

Various other variations and modifications can be conceived by those skilled in the art within the spirit of the invention, and it is understood that such variations and modifications are also encompassed within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A sensor, comprising:
a base including a first face;
a fixed portion fixed to the first face; and
a movable portion supported by the fixed portion,
a first gap being provided between the first face and the movable portion,
the movable portion including a plurality of annular portions, a plurality of connect portions, and a first radial structure,
each of the plurality of annular portions being provided around the fixed portion with the fixed portion as a center in a first plane along the first face,
the plurality of connect portion extending along a radial direction,
the radial direction passing through a first center of the fixed portion in the first plane and being along the first plane,
one of the plurality of connect portions connecting two of the plurality of annular portions to each other,
the plurality of annular portions including a first annular portion and a second annular portion,
the second annular portion being next to the first annular portion among the plurality of annular portions,
the first radial structure being connected to the first annular portion,
the first radial structure extending toward the second annular portion along a first radial direction,
the first radial direction passing through the first center and being along the first plane, and
a first radial gap being provided between the first radial structure and the second annular portion.

2. The sensor according to claim 1, wherein
the second annular portion is provided between the fixed portion and the first annular portion.

3. The sensor according to claim 1, wherein
the movable portion further includes a first opposing radial structure,
the first opposing radial structure is connected to the second annular portion,
the first opposing radial structure extends toward the first radial structure along the first radial direction, and
the first radial gap is provided between the first radial structure and the first opposing radial structure.

4. The sensor according to claim 1, further comprising:
a first fixed electrode fixed to the first face; and
a first other fixed electrode fixed to the first face,
the first fixed electrode and the first other fixed electrode being provided between the second annular portion and the first annular portion, and
at least a part of the first radial structure being provided between the first fixed electrode and the first other fixed electrode in a circumferential direction centered on the fixed portion along the first plane.

5. The sensor according to claim 1, further comprising:
a first fixed electrode fixed to the first face,
the first fixed electrode being provided between the second annular portion and the first annular portion,
the plurality of connect portions including a first connect portion,
the first connect portion being provided between the second annular portion and the first annular portion,
the first connect portion connecting the second annular portion to the first annular portion, and
the first fixed electrode being provided between the first radial structure and the first connect portion in a circumferential direction centered on the fixed portion along the first plane.

6. The sensor according to claim 1, wherein
the movable portion further includes a second radial structure,
the plurality of annular portions further include a third annular portion,
the second annular portion is provided between the fixed portion and the first annular portion,
the third annular portion is provided between the fixed portion and the second annular portion,
the third annular portion is next to the second annular portion among the plurality of annular portions,
the second radial structure is connected to the second annular portion,
the second radial structure extends toward the third annular portion along a second radial direction,
the second radial direction passes through the first center and is along the first plane, and
a second radial gap is provided between the second radial structure and the third annular portion.

7. The sensor according to claim 6, wherein
the second radial direction is along the first radial direction.

8. The sensor according to claim 6, wherein
the movable portion further includes a second opposing radial structure,
the second opposing radial structure is connected to the third annular portion,
the second opposing radial structure extends toward the second radial structure along the second radial direction, and
the second radial gap is provided between the second radial structure and the second opposing radial structure.

9. The sensor according to claim 6, further comprising:
a second fixed electrode fixed to the first face, and a second other fixed electrode fixed to the first face,
the second fixed electrode and the second other fixed electrode being provided between the third annular portion and the second annular portion, and
at least a part of the second radial structure being provided between the second fixed electrode and the second other fixed electrode in a circumferential direction centered on the fixed portion along the first plane.

10. The sensor according to claim 1, wherein
the movable portion further includes a third radial structure,
the plurality of annular portions further include a third annular portion and a fourth annular portion,
the fourth annular portion is next to the third annular portion among the plurality of annular portions,
the third radial structure is connected to the third annular portion,
the third radial structure extends toward the fourth annular portion along a third radial direction,
the third radial direction passes through the first center and is along the first plane, and
a third radial gap is provided between the third radial structure and the fourth annular portion.

11. The sensor according to claim 10, wherein
the third radial direction crosses the first radial direction.

12. The sensor according to claim 10, wherein
the second annular portion is provided between the fixed portion and the first annular portion,
the third annular portion is provided between the fixed portion and the second annular portion, and
the fourth annular portion is provided between the fixed portion and the third annular portion.

13. The sensor according to claim 10, wherein
the movable portion further includes a third opposing radial structure,
the third opposing radial structure is connected to the fourth annular portion,
the third opposing radial structure extends toward the third radial structure along the third radial direction, and
the third radial gap is provided between the third radial structure and the third opposing radial structure,

14. The sensor according to claim 10, further comprising:
a third fixed electrode fixed to the first surface, and a third other fixed electrode fixed to the first surface,
the third fixed electrode and the third other fixed electrode being provided between the fourth annular portion and the third annular portion, and
at least a part of the third radial structure being provided between the third fixed electrode and the third other fixed electrode in a circumferential direction centered on the fixed portion along the first plane.

15. The sensor according to claim 6, wherein
the movable portion further includes a fourth radial structure,
the plurality of annular portions further include a fourth annular portion,
the fourth annular portion is provided between the fixed portion and the third annular portion,
the fourth radial structure is connected to the fourth annular portion,
the fourth radial structure extends toward the fixed portion along the second radial direction, and
a fourth radiation gap is provided between the fourth radial structure and the fixed portion.

16. The sensor according to claim 15, wherein
the movable portion further includes a fourth opposing radial structure,
the fourth opposing radial structure is connected to the fixed portion,
the fourth opposing radial structure extends toward the fourth radial structure along the second radial direction, and
the fourth radial gap is provided between the fourth radial structure and the fourth opposing radial structure.

17. The sensor according to claim 15, further comprising:
a fourth fixed electrode fixed to the first face, and a fourth other fixed electrode fixed to the first face,
the fourth fixed electrode and the fourth other fixed electrode being provided between the fixed portion and the fourth annular portion, and
at least a part of the fourth radial structure being provided between the fourth fixed electrode and the fourth other fixed electrode in a circumferential direction centered on the fixed portion along the first plane.

18. The sensor according to claim 1, wherein
a length of the first radial gap in the first radial direction is not less than 0.1 times and not more than 0.9 times a distance between the second annular portion and the first annular portion along the first radial direction.

19. A sensor system, comprising:
the sensor according to claim 1; and
a detection target member, the sensor being fixed to the detection target member.

20. An electronic device, comprising:
the sensor according to claim 1; and
a circuit controller configured to control a circuit based on a signal obtained from the sensor.
